(19) United States
(12) Patent Application Publication
(10) Pub. No.: US 2008/0274809 A1
(43) Pub. Date: Nov. 6, 2008

(54) Interactive image throwing apparatus

(76) Inventor: Hong Chang, Taipei City (TW)

Correspondence Address: Joe McKinney Muncy, PO Box 1364, Fairfax, VA, 22038-1364, US

(21) Appl. No.: 11/797,181

(22) Filed: May 1, 2007

(51) Int. Cl. A63F 13/00

(52) U.S. Cl. 463/33

(57) ABSTRACT

An interactive image throwing apparatus includes a throwing device for ball games that has a plurality of sensors and a display interface to allow users to throw balls made from different materials to image game pictures displayed on the display interface. The sensors detect throwing signals and send the signals back to a host for processing. The throwing game can be played by maneuvering and controlling the image game pictures on the display interface to perform an image and throwing interactive exercise.

### FIELD OF THE INVENTION

The present invention relates to a throwing exercise apparatus and particularly to an interactive image throwing apparatus that couples a ball throwing exercise with an interactive image game.

### BACKGROUND OF THE INVENTION

Nowadays people have a higher demand for living quality. One of the important factors affecting the living quality is the availability of diversified entertainment activities. Advances of electronic and information technologies make many types of electronic products to become important tools of entertainment, such as CD players, VCD or DVD movies, electronic exercise equipment, electronic games and the like.

Electronic games provide interactive function, hence they have a great appeal to many people. Users can get a feeling of achievement and improve brain power and coordination ability during the process of playing the game.

At present many electronic game companies have invested a great deal resources to develop novel interactive electronic game software and hardware. As the interactive electronic game industry does not create pollution and offers high added value, many governments in the world have fostered and encouraged domestic industry to do research, development and innovation in this area.

In the interactive game, music interactive game is one type that attracts a lot of attention. The so called music interactive game has special features like animation and music rhythm, and requires users to perform selected activities according to the animation and music rhythm. The result of the game depends on the coordination of the users. In the interactive game users not only can enjoy music and diversified animations, also can practice coordination capability. The process gives the users a sense of achievement.

One of the factors that gives the interactive game novelty and attractive power is the diversity of the interactive pictures and interactive apparatus. For instance, a dancing machine can be produced through a responsive panel, and a shooting game can be made through optical sensitivity. By means of different interactive apparatus users can get different kinds of amusements and pleasures.

The user's demands grow constantly. The game becomes more diversified. How to develop a new mechanism to satisfy users and enhance the value of the entire interactive game is a great challenge.

### SUMMARY OF THE INVENTION

The primary object of the present invention is to provide an interactive image throwing exercise apparatus which includes a ball throwing means and a plurality of sensors to allow users to throw various types of balls to selected game pictures. Through detections of the sensors the throwing exercise and game playing are combined.

The interactive image throwing apparatus according to the invention includes a throwing device which has a plurality of throwing elements, a host containing a game software unit and a signal processing unit, a display unit which has a display interface to display game pictures transmitted from the game software unit and a plurality of sensors corresponding to the display interface to detect position signals when the throwing elements are thrown to the display interface and transmit the signals to the signal processing unit.

In one aspect, the throwing elements are balls made from various types of material. The game software unit in the host contains different interactive game software designed according to user's requirements.

In another aspect, the sensors are mechanical contact switch elements or thin film touch sensitive elements located on the display interface, or CMOS sensors and infrared image elements to scan or detect the surface of the display interface.

In yet another aspect, the sensors are linked to the host through a transmission interface which may be wired transmission or wireless transmission.

It yet another aspect, the display interface is a display device or an image projection display device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the interactive image throwing apparatus of the invention.

FIG. 2 is a system block diagram of the invention.

FIG. 3 is another schematic view of the interactive image throwing apparatus of the invention.

### DETAILED DESCRIPTION OF THE PREFERRED EMBODIMENT

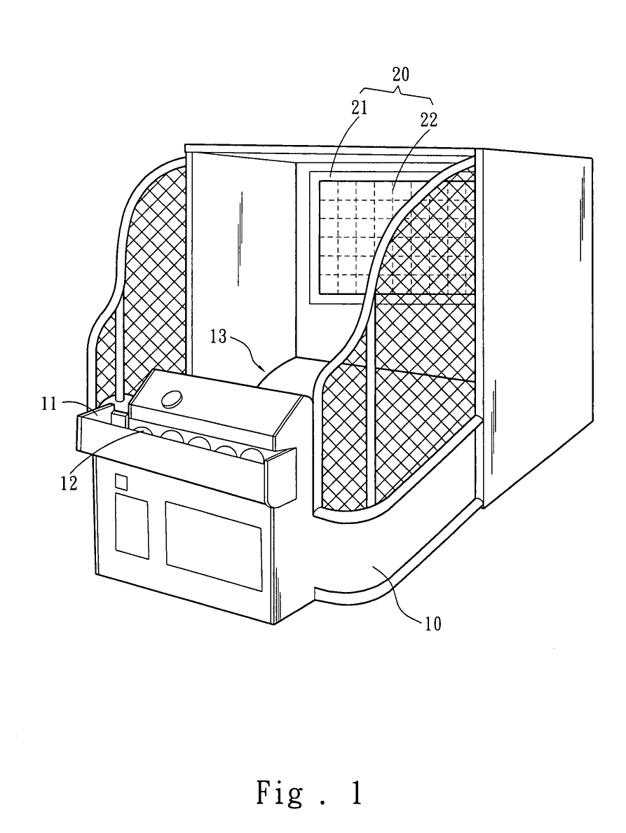

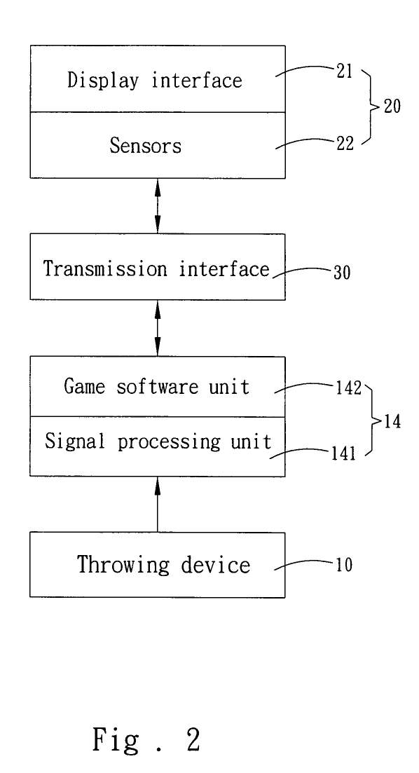

Please refer to FIGS. 1 and 2, the interactive image throwing apparatus of the invention includes a throwing device 10 which has a first housing compartment 11 to hold a plurality of throwing elements 12, a second housing compartment 13 to provide a throwing space and receive the thrown throwing elements 12. The throwing elements 12 are balls made from various materials. A host 14 is provided which includes a game software unit 142 and a signal processing unit 141. The game software unit 142 contains different interactive game software designed according to user's requirements to provide various types of interactive game pictures and music.

There is also a display unit 20 which includes a display interface 21 to display game pictures transmitted from the game software unit 142. A plurality of sensors 22 are provided corresponding to the display interface 21. The sensors 22 aim to detect positional signals of the throwing elements 12 thrown to the display interface 21, and transmit the signals to the signal processing unit 141.

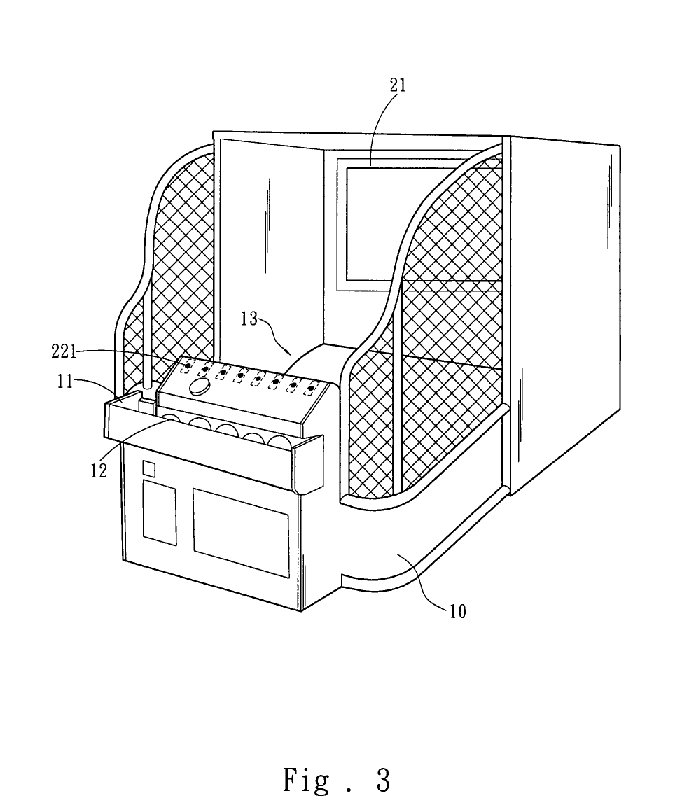

The sensors 22 are mechanical contact switch sensors or film touch sensitive elements (referring to FIG. 1). They also may be other types of sensors 221 such as CMOS sensors and infrared image elements (referring to FIG. 3) to scan and detect the surface of the display interface 21. They may be installed on a location opposite to the surface of the display interface 21 to scan and detect the position of the throwing elements 12 on the display interface 21. Depending on different characteristics of the sensors 22 and 221 and the display interface 21, they may be installed at different locations.

The sensors 22 and 221 may be linked to the host 14 through a transmission interface 30. The transmission interface 30 may be wired transmission or wireless transmission, such as IR (Infrared red), RF (Radio frequency), Bluetooth, USB, game port, RS232, RS422 or the like. When the sensors 22 and 221 detect the signals of the throwing elements 12 thrown to the display interface 21, the signal are transmitted to the signal processing unit 141 of the host 14 to be processed and converted to scores. The scores are displayed on the display interface 21 to inform users. The display interface 21 may be an ordinary display device or an image projection display device.

In short, the invention provides the throwing device 10 to allow the throwing elements 12 in the forms of balls made from various types of materials to be thrown to the image game pictures on the display interface 21. Through the sensors 22 the thrown signals are detected and transmitted back to the signal processing unit 141 in the host 14 of the throwing device 10. The host 14 processes the signals of the throwing elements 12 thrown to the animation game pictures to get the scores and inform users. By maneuvering and controlling the image on the game picture shown on the display interface 21, the throwing exercise and game can be combined.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An interactive image throwing apparatus, comprising:
a throwing device including a plurality of throwing elements;
a host including a game software unit and a signal processing unit; and
a display unit which includes a display interface to display game pictures transmitted from the game software unit and a plurality of sensors corresponding to the display interface, the sensors detecting positional signals of the throwing elements thrown to the display interface and transmitting the signals to the signal processing unit.

2. The interactive image throwing apparatus of claim 1, wherein the throwing elements are balls made from varying materials.

3. The interactive image throwing apparatus of claim 1, wherein the game software unit has interactive game software designed according to varying user's requirements.

4. The interactive image throwing apparatus of claim 1, wherein the sensors are selectively mechanical contact switch sensors or film touch-sensitive elements located on the display interface.

5. The interactive image throwing apparatus of claim 1, wherein the sensors are selectively CMOS sensors or infrared image elements to scan and detect the surface of the display interface.

6. The interactive image throwing apparatus of claim 1, wherein the sensors are linked to the host through a transmission interface.

7. The interactive image throwing apparatus of claim 6, wherein the transmission interface is wired transmission.

8. The interactive image throwing apparatus of claim 6, wherein the transmission interface is wireless transmission.

9. The interactive image throwing apparatus of claim 1, wherein the display interface is a display device.

10. The interactive image throwing apparatus of claim 1, wherein the display interface is an image projection display device.
